(19) United States
(12) Patent Application Publication
(10) Pub. No.: US 2006/0279084 A1
(43) Pub. Date: Dec. 14, 2006

(54) Two-shot or insert molded cuffs for welding onto clean air ducts

(76) Inventor: Daniel J. Collins, Akron, OH (US)

Correspondence Address: William G. Muller, 388 South Main Street, Akron, OH, 44311, US

(21) Appl. No.: 11/152,281

(22) Filed: Jun. 14, 2005

(51) Int. Cl. F16L 25/00; B29C 65/00

(52) U.S. Cl. 285/328; 264/248

(57) ABSTRACT

An air duct includes a rigid thermoplastic body having softer elastomeric cuff members welded to the ends thereof. The cuff members comprise an outer sealing component and a weldable insert bonded to at least a portion of the inner surface. The cuff members are adhered to the thermoplastic body at the weldable insert through a spin welding or other suitable welding process. The chemical compatibility between the insert and the thermoplastic body provides a robust weld at the interface.

### FIELD OF INVENTION

The present invention relates broadly to the field of air ducts, and more particularly to a coupling member and a method of joining an elastomeric cuff comprising a first material to the open end of a molded air duct body formed of a second material. The air ducts may be particularly adapted for vehicular use.

### BACKGROUND ART

Air ducts are known for use on internal combustion engine applications for a number of purposes. For example, they are used to transport clean air from an air filter through the air intake system. They are also used to transport air from the engine compartment to and within the passenger compartment.

It is desirable to have an air duct with good sealing qualities at the interface between the body of the air duct and the vehicular or other components. Although materials such as polypropylene are adequate for air duct bodies, the material does not readily conform to sealing surfaces to make airtight seals.

Some prior art techniques have been employed to address the problem of providing an air duct body having sealable end regions.

One approach is to mold the complete air duct from an elastomer with good sealing and assembly properties. However, this approach carries a high cost burden. Additionally, this approach is hampered by the durometer limits of material that can be employed. Typically materials in the 80 A durometer range make up the lower limits of this approach, yet OEM sealing and assembly preferences lean toward materials exhibiting less than 80 durometer. Also, the air duct geometry may also limit its ability to be produced with good sealing and assembly characteristics.

Another approach is to utilize a sequential 3-dimensional blow molding or exchange blow molding process. Using this process a softer material can be incorporated onto the sealing ends of the air duct. However, process and material limitations prevent the production of an air duct with cuff material exhibiting less than about 80 A durometer.

Yet another approach is disclosed in U.S. Pat. No. 5,529,743 to Powell and U.S. Pat. No. 6,135,158 to Kraus. In the disclosed process, a cuff portion is injection over-molded onto the end of an air duct formed by a blow molding process. In the over-molding process, the cuff portion is added independently of the blow molding process. A first thermoplastic material, such as polypropylene, may be utilized in the air duct body. A second, softer material may be utilized in the cuff portion. This process allows different, lower cost thermoplastics to be used for the air duct body independently of the cuff.

Disadvantages associated with the over-molding process include high tooling cost as both a blow mold and an injection mold must be used to produce a finished part. Injection tooling can be complex. Also, there may be an increase in cycle times due to the manual loading of the blow molded part into the injection mold. The range of part size can require a wide range of molding equipment to produce complex or large air ducts.

Finally, a cuff member can be welded onto the end of the air duct. To date, welding has been a viable option for adding sealing members to air ducts. The welding process occurs subsequent to formation of the duct body. In practice, the strength of the bond between dissimilar materials is limited by the pressure and temperature associated with the welding process. In addition, this approach is limited by the inability to generate a robust weld with elastomers having durometer values below 80 A due to the low polymer content present in the softer elastomers.

Thus, there exists a need in the art to incorporate a soft cuff (less than 80 A durometer) onto an air duct body to enhance sealing performance and increase ease of assembly and installation.

### DISCLOSURE OF INVENTION

In accordance with an exemplary embodiment, a cuff member comprising softer elastomeric material is joined to an air duct body formed of more rigid polymeric material through operation of a bridge member insert.

In accordance with an exemplary embodiment, an article is provided having at least one open-ended cuff member. The cuff member includes a first outer sealing component comprising a thermoplastic elastomer having a durometer hardness of less than about 90 Shore A and at least one inner weldable layer section comprising a thermoplastic material capable of welding both to a thermoplastic body of suitable size for tight fitting insertion and to at least a portion of an inner surface of the outer layer sealing component section.

The cuff member may include an annular channel formed on its outer surface, axially spaced from one end.

In an exemplary embodiment, the article further includes a tubular duct member comprising a thermoplastic body having at least one annular open end which is welded to the inner layer of the insert section.

In an exemplary embodiment, the article further includes a second cuff member substantially identical to the first cuff member to which a second open end of the tubular duct member is welded.

In an exemplary embodiment, the thermoplastic elastomer of the first outer layer sealing component has a durometer hardness of less than about 90 Shore A, and more preferably less than about 80 Shore A. In other exemplary embodiments, the durometer hardness of the thermoplastic elastomer is between about 55 Shore A and about 73 Shore A.

In an exemplary embodiment, the thermoplastic elastomer is a dynamic vulcanizate thermoplastic elastomer. The dynamic vulcanizate thermoplastic may comprise polyolefin thermoplastics. Likewise, the thermoplastic material of the inner layer weldable section may comprise polyolefin thermoplastics. The polyolefin thermoplastics may be selected from polyethylene or polypropylene homopolymers or copolymers having a Tm by DSC of at least 120°, or mixtures thereof.

In accordance with an exemplary embodiment there is provided a process for incorporating a cuff comprising softer elastomeric material onto a molded air duct body. The cuff is incorporated onto the air duct body by a multi-step process.

In one exemplary embodiment, a weldable layer section is added to the softer sealing component by a 2-shot injection molding process. 2-shot molding injection requires that the two materials to be bonded be chemically compatible, or no bonding occurs. In a 2-shot injection molding process, a single mold is utilized to form a unitary part comprising distinct “zones” comprising different materials. By this process, the more rigid polymer weldable section can be bonded to the softer elastomeric component to form the cuff member. In this exemplary process, a robust bond is formed at the interface between the weldable section and the cuff member because of precise part designs and higher pressure and temperature molding conditions. Ultimately, the weld between the cuff member and the air duct body is improved because of the chemical compatibility of the weldable section with both the elastomeric component of the cuff member and the air duct body. In one exemplary embodiment, the cuff member is adhered to the air duct body by a spin welding operation.

Alternately, in the 2-shot injection molding process, the weldable insert may be molded in an initial operation and then the softer elastomeric material introduced to the mold to form the sealing component of the cuff member.

Alternately, the weldable section may be added to the softer elastomeric sealing component by an insert injection molding (or overmolding) process. Insert molding comprises placing a previously molded insert into a mold and injecting material onto it. Use of compatible materials leads to a melt bond at the interface between the two materials. In this exemplary embodiment, a previously molded weldable section member is placed in a mold and a chemically compatible elastomeric material is molded over the insert to form the cuff member. Thereafter, the cuff member is adhered to the air duct body in an additional process step, such as spin welding.

Alternately, the previously molded softer elastomeric sealing component is placed in the mold and a chemically compatible weldable material is molded onto the soft elastomeric sealing component to form the cuff member. Thereafter, the cuff member is adhered to the air duct body in an additional process step, such as spin welding.

Both methods of forming the cuff member, i.e. 2-shot injection molding or insert injection molding, provide a weldable section to enhance the ultimate weld between a polyolefin (or rigid) thermoplastic air duct body and a cuff member comprising a softer sealing component. Thus, for example, a polypropylene air duct body could be welded to a cuff incorporating a softer (i.e., <80 durometer) sealing component via the polypropylene weldable section. The interface between the softer sealing component and the weldable insert is enhanced by the chemical compatibility of the materials. Likewise, the interface between the weldable insert and the body portion comprises an intimate joint between the materials used. Thus the weldable insert provides a means to join two materials having dissimilar physical properties (i.e., soft vs. rigid).

One advantage of the exemplary embodiments is that a cuff member comprising a softer elastomeric material may be welded to an air duct body.

Another advantage of the exemplary embodiments is that the insert is used to bridge the gap in chemical compatibility between the softer cuff member and the more rigid air duct body.

Another advantage of the exemplary embodiments is that the less expensive materials used to form the air duct body can be robustly welded to sealable cuff members.

Another advantage of exemplary embodiments is that an air duct body and a cuff member comprising a softer elastomeric component may be spin welded together.

Still other advantages of exemplary embodiments of the present invention will be apparent to those having skill in the art upon a reading and understanding of the specification.

### BRIEF DESCRIPTION OF THE DRAWINGS

The features and inventive aspects of the present invention will become more apparent upon reading the following detailed description, claims, and drawings, of which the following is a brief description:

FIG. 1 is a perspective view of an air duct in accordance with an exemplary embodiment of the invention;

FIG. 2 is a reference chart showing the durometer scale;

FIG. 3 is a partial sectional view of a body portion and a unitary cuff member prior to a combination of elements; and

FIG. 4 is a partial sectional view of an exemplary embodiment of an air duct wherein the body portion is welded to the cuff member.

### BEST MODES FOR CARRYING OUT INVENTION

Definitions:

Thermoplastic Elastomer (TPE): a diverse family of rubber-like materials that, unlike conventional vulcanized rubbers, can be processed and recycled like thermoplastic materials. Typical examples include blends of “hard” crystalline, semi-crystalline, or glassy polymers (for instance those having a Tm greater than about 110° C. or Tg greater than about 60° C., as measured by differential scanning calorimetry (DSC), more preferably with amorphous or low-crystallinity polymers (Tm less than about 90° C. or Tg less than 60° C. by DSC). Examples of hard polymers include the non-polar and polar engineering resins such as polypropylene, polyethylene, polyamide, polycarbonate, and polyester resins. The “soft” polymers include most rubbers, particularly the non-polar olefin rubbers, for hard polyolefins, and polar rubbers for polar hard resins. Non-polar rubbers include ethylene-propylene rubber, very low density polyethylene copolymers comprising C4 to C8 α-olefin or vinyl aromatic comonomers, butyl rubber, natural rubber, styrene-butadiene rubber butadiene rubber, butadiene rubber and the like. Compatibilizing block copolymers and/or functionalized polymers are often used to improve overall engineering properties where incompatibility may exist as in blends of non-polar and polar polymers.

Additional thermoplastic elastomers are represented by the class of block copolymers where at least one block is a hard block, or polymer segment, and at least one other is a soft block or polymer segment. Examples include the styrene block copolymers (SBC) and thermoplastic polyurethane. The SBC thermoplastic elastomers useful in the invention are block copolymers of styrene/conjugated diene/styrene, with the conjugated diene optionally being fully or partially hydrogenated, or mixtures thereof. Generally this block copolymer may contain 10 to 50 weight %, more preferably 25 to 35 weight %, of styrene and 90 to 50 weight %, more preferably 75 to 35 weight % of the conjugated diene, based on said block copolymer. Most preferred, however, is a block copolymer which contains 28 to 35 weight % of styrene and 68 to 72 weight % of the conjugated diene. The conjugated diene is selected from butadiene, isoprene or mixtures thereof. Block copolymers of the styrene/conjugated diene/styrene type are SBS, SIS, SIBS, SEBS and SEPS, and SEEPS block copolymers.

These block copolymers useful in the compositions of the invention are known in the art, and are further described in Canadian Pat. No. 2,193,264 and in International Pat. Applications WO 96/20248; WO 96/23823; WO 98/12240; and WO 99/46330. They are generally prepared by butyl lithium initiated sequential anionic polymerization, but coupling of living S-B/S diblocks or bifunctional initiation are also known methods. See, in general, Thermoplastic Elastomers (2nd Ed.), Ch. 3, G. Holden, N. Legge, et al (Hanser Publishers, 1996).

Another suitable thermoplastic elastomeric material is thermoplastic polyurethane (TPU) prepared from substantially difunctional ingredients, i.e. organic diisocyanates and components being substantially difunctional in active hydrogen containing groups, particularly those that have at least one major Tg of less than 60° C. However, often minor proportions of ingredients with functionalities higher than two may be employed. This is particularly true when using extenders such as glycerol, trimethylol propane, and the like. Any of the TPU materials known in the art within this description can be employed within the scope of the present invention. The preferred TPU is a polymer prepared from a mixture comprising at least one organic diisocyanate, at least one polymeric diol and at least one difunctional extender. The TPU can be prepared by prepolymer, quasi-prepolymer or one-shot methods commonly used in the art, see International Pat. Application No. WO 01 10950 (A1) (above) and references cited therein.

Thermoplastic Vulcanizate (TPV): a thermoplastic elastomer with a “hard” thermoplastic phase and a “soft” chemically crosslinked rubbery phase, produced by dynamic vulcanization. TPVs provide functional performance and properties similar to conventional thermoset rubber products, but can be processed with the speed, efficiency and economy of thermoplastics. In addition to simpler processing, principal advantages of TPVs compared to thermoset rubber products include easier recycling of scrap and closer, more economical control of dimensions and product quality.

Dynamic Vulcanization: the process of intimate melt mixing a thermoplastic polymer and a suitable vulcanizable rubbery polymer with a cross-linking or vulcanization agent to generate a thermoplastic elastomer with a chemically crosslinked rubbery phase, resulting in properties closer to those of a thermoset rubber when compared to the same uncrosslinked composition. Thermoplastic vulcanizates and processes for preparing them are well known in the art, see for example, U.S. Pat. Nos. 4,130,535, 4,311,628, 4,594,390, and 5,672,660, and “Dynamically Vulcanized Thermoplastic Elastomers”, S. Abdou-Sabet, et al, Rubber Chemistry and Technology, Vol. 69, No. 3, July-August 1996, and references cited therein. Examples of commercially available TPV products are the SANTOPRENE® thermoplastic vulcanizate products from Advanced Elastomer Systems, L.P.

Vulcanizable or cross-linkable rubbery polymers can be any rubber that can react and be crosslinked under crosslinking conditions. These rubbers can include natural rubber, EPM and EPDM rubber, butyl rubber, halobutyl rubber, halogenated (e.g. brominated) copolymers of p-alkylstyrene and an isomonoolefin, homo or copolymers from at least one conjugated diene, or combinations thereof. EPDM, butyl and halobutyl rubbers are referred to as rubbers low in residual unsaturation and are preferred when the vulcanizate needs good thermal stability or oxidative stability. The rubbers low in residual unsaturation desirably have less than 10 weight percent repeat units having unsaturation. For the purpose of this invention, copolymers will be used to define polymers from two or more monomers, and polymers can have repeat units from one or more different monomers.

An easily cross-linkable rubber is preferred if at least partial cross-linking is selected. The cross-linkable rubber is desirably an olefin rubber such as EPDM-type rubber. EPDM-type rubbers are generally terpolymers derived from the polymerization of at least two different monoolefin monomers having from 2 to 10 carbon atoms, preferably 2 to 4 carbon atoms, and at least one polyunsaturated olefin having from 5 to 20 carbon atoms. Said monoolefins desirably have contain 1-12 carbon atoms and are preferably ethylene and propylene, but ethylene with 1-butene, 1-hexene, or 1-octene, are also readily suitable. Desirably the repeat units from at least two monoolefins are present in the polymer in weight ratios of 25:75 to 75:25 (ethylene: propylene) and constitute from about 90 to about 99.6 weight percent of the polymer. The polyunsaturated olefin can be a straight chained, branched, cyclic, bridged ring, bicyclic, fused ring bicyclic compound, etc., and preferably is a nonconjugated diene. Desirably repeat units from the nonconjugated polyunsaturated olefin is from about 0.4 to about 10 weight percent of the rubber. Preferred nonconjugated diolefins have 5 to 20 carbon atoms, preferably one or more selected from 1,4-hexadiene, ethylidene norbornene, vinyl norbornene, dicyclopentadiene, and the like.

The rubber can be a butyl rubber, halobutyl rubber, or a halogenated (e.g. brominated) copolymer of p-alkylstyrene and an isomonoolefin of 4 to 7 carbon atoms. “Butyl rubber” is defined a polymer predominantly comprised of repeat units from isobutylene but including a few repeat units of a monomer which provides sites for crosslinking. The monomers which provide sites for crosslinking can be a polyunsaturated monomer such as a conjugated diene or divinyl benzene. Desirably from about 90 to about 99.5 weight percent of the butyl rubber are repeat units derived from the polymerization of iso-butylene, and from about 0.5 to about 10 weight percent of the repeat units are from at least one polyunsaturated monomer having from 4 to 12 carbon atoms. Preferably the polyunsaturated monomer is isoprene or divinylbenzene. The polymer may be halogenated to further enhance reactivity in crosslinking. Preferably the halogen is present in amounts from about 0.1 to about 10 weight percent, more preferably about 0.5 to about 3.0 weight percent based upon the weight of the halogenated polymer; preferably the halogen is chlorine or bromine. Suitable rubbers include a brominated copolymer of p-alkylstyrene, having from about 9 to 12 carbon atoms, and an isomonoolefin, having from 4 to 7 carbon atoms, desirably such will have from about 88 to about 99 weight percent isomonoolefin and from about 1 to about 12 weight percent p-alkylstyrene based upon the weight of the copolymer before halogenation. Desirably the alkylstyrene is p-methylstyrene and the isomonoolefin is isobutylene. These polymers are commercially available from ExxonMobil Chemical Co.

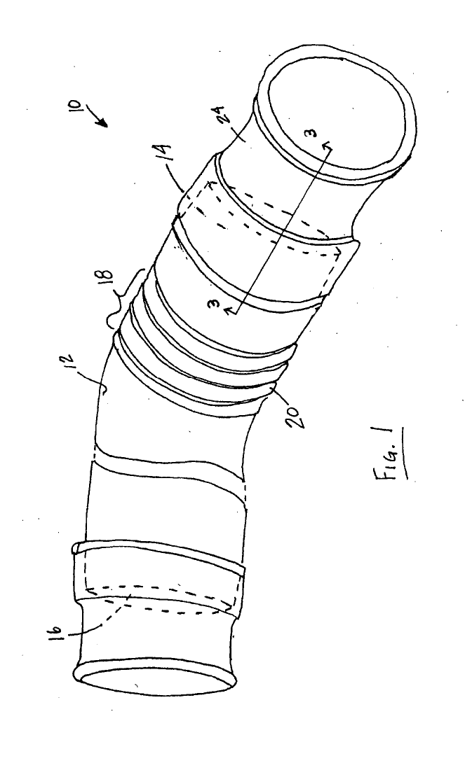

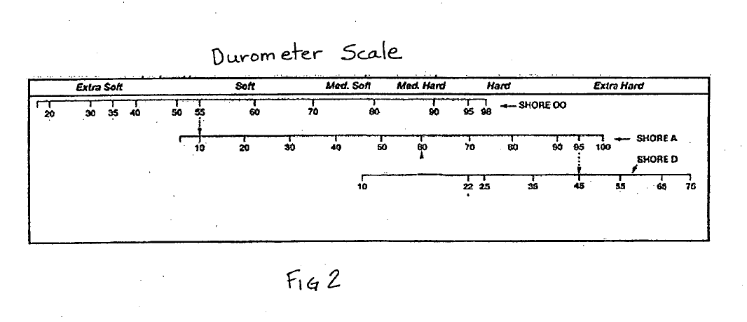

With reference to the drawings, and in particular to FIG. 1, an air duct according to the present invention is referred to generally by the numeral 10. The air duct 10 has a tubular body portion 12 with a first open first and second ends 14, 16, shown in phantom in FIG. 1. A flexible region 18 may be formed in body portion 12 consisting of a plurality of sequentially spaced convolutions 20 to facilitate engine movement and installation of the air duct 10.

It should be appreciated that any size, shape, or configuration of a tubular body may be used for transferring a flow of air from one point to another, while still incorporating the elements of the present invention. Generally, the size and shape of body portion 12 will be governed by the particular application of air duct 10 and is not limited to embodiments shown herein.

The body portion 12 is preferably molded from a thermoplastic polymeric material. Examples include such as a homopolymer or copolymer polypropylene or polyethylene material, which may include polypropylene thermoplastic/ethylene propylene rubber (EPR) or ethylene propylene diene monomer rubber (EPDM) blends. Other polymers that can be employed for instance include polypropylene, reinforced polypropylene (e.g., fiber, mica, talc, or glass bead filled), polyphenylene oxide/nylon blends, polyvinyl chloride and reinforced polyvinylchloride, and other thermoplastic engineering resins. The foregoing list is not to be construed as limiting but is rather merely exemplary of suitable materials. The method of molding body portion 12 does not form a part of the present invention. Generally, the body portion 12 comprises a rigid thermoplastic structure.

With reference again to FIG. 1, air duct 10 includes at least one cuff member 24 secured to body portion 12 at the first end 14. In an exemplary embodiment, a similar cuff member 24 is also secured to body portion 12 at the second end 16. The cuff member 24 is provided to enable the air duct 10 to be readily attached to other structures. Cuff member 24 comprises a sealing component 26 formed of a thermoplastic elastomer (TPE). The thermoplastic elastomeric materials utilized in an exemplary form of the present invention include various grades of Santoprene™ thermoplastic vulcanizates available from Advanced Elastomer Systems, L.P., Akron, Ohio. An exemplary grade designation includes Santoprene™ 101-55, which has a Shroe A durometer of 55. In the exemplary embodiment, the TPE has a hardness of less than about 80 on the Shore A durometer scale. In the exemplary embodiment, the sealing component 26 is formed of a thermoplastic vulcanizate (TPV) that provides the advantages discussed above.

The hardness testing of soft plastics such as rubber, cellular materials, elastomeric materials, thermoplastic elastomers and some hard plastics is most commonly measured by the Shore (Durometer) test. The method measures the resistance of the plastic toward indentation. Shore Hardness, using either the Shore A or Shore D scale, is the preferred method for rubbers/elastomers and is also commonly used for ‘softer’ plastics such as polyolefins, fluoropolymers, and vinyls. The Shore A scale is used for ‘softer’ rubbers while the Shore D scale is used for ‘harder’ ones. The shore A Hardness is the relative hardness of elastic materials such as rubber or soft plastics determined with an instrument called a Shore A durometer. If the indenter completely penetrates the sample, a reading of 0 is obtained, and if no penetration occurs, a reading of 100 results. The reading is dimensionless.

The Shore hardness is measured with an apparatus known as a Durometer and consequently is also known as ‘Durometer hardness’. The hardness value is determined by the penetration of the Durometer indenter foot into the sample. Because of the resilience of rubbers and plastics, the hardness reading my change over time—so the indentation time is sometimes reported along with the hardness number. The ASTM test number is ASTM D2240 while the analogous ISO test method is ISO 868.

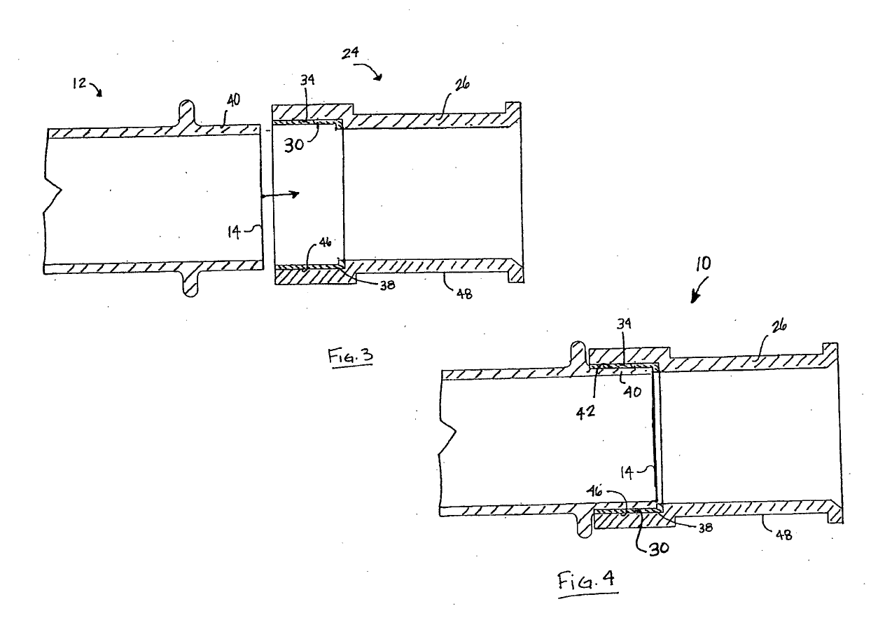

With reference to FIG. 3, a weldable insert 30 is disposed in the interior of cuff member 24 along at least a portion of its length. In the exemplary embodiment, the sealing component 26 and weldable insert 30 comprise a unitary part forming cuff member 24 prior to attachment to body portion 12.

In the exemplary embodiment, weldable insert 30 comprises a thermoplastic material that is capable of welding to at least a portion of an inner surface 34 of the outer sealing component 26. Use of the terms “weld,” “weldable,” and “welding” refer to an intimate interconnection formed between two materials by chemical means. Alternately, the connection could be described using the terms “bond,”, “bondable,” and “bonding.” In the exemplary embodiment, the thermoplastic material of which the insert 30 is comprised is capable of welding to the material of which sealing component 26 is comprised. Thus, although FIG. 3 indicates a clear demarcation between insert 30 and sealing component 26, it should be understood by those skilled in the art that a chemical interconnection is present at the interface 38 between insert 30 and sealing component 26.

Also, in the exemplary embodiment, weldable insert 30 comprises a thermoplastic material that is capable of welding to at least a portion of the body portion 12. As illustrated in FIG. 3, body portion 12 comprises an end region 40 adapted for tight fitting insertion into cuff member 24 in the area of weldable insert 30.

FIG. 4 illustrates a portion of the fully-formed air duct 10. Although FIG. 4 illustrates a clear demarcation between insert 30 and body portion 12, it should be understood by those skilled in the art that a chemical interconnection is present at the interface 42 between insert 30 and the end region 40 of body portion 12.

In the exemplary embodiment, weldable insert 30 comprises polyolefin thermoplastic including for example polypropylene and polyethylene homopolymers or copolymers having a Tm by DSC of at least 120°, or mixtures thereof.

Weldable insert 30 functions as a bridge element to provide a robust connection between the more rigid material of which body portion 12 is formed and the softer material of which the sealing component 26 is formed. The air duct 10 is formed in a multi-step process as detailed below.

In one exemplary process, the unitary cuff member 24 comprising sealing component 26 and weldable insert 30 is formed by a two-shot injection molding process.

In a first exemplary embodiment, sealing component 26 is formed in a suitable mold using injection molding techniques that are well known in the art. The sealing component 26 is molded as the “first-shot” using a first compound comprising the exemplary TPE. In a “second-shot” step, the weldable insert 30 is provided along at least a portion of an inner surface 34 of sealing component 26 using a second compound comprising the exemplary thermoplastic material. This two-shot molding process occurs at sufficient temperature and pressure conditions to provide a robust chemical interconnection at the interface 42 between the sealing component 26 and the weldable insert 30.

Alternately, the weldable insert 30 can be formed in the “first-shot” by injecting the exemplary thermoplastic material into a suitable mold and thereafter directing the “second-shot” of the exemplary TPE material about an outer surface 46 of the insert 30. Again, this two-shot molding process occurs at sufficient temperature and pressure conditions to provide the desired chemical interconnection at interface 42.

In an alternate exemplary embodiment, cuff member 24 is formed by an over-molding process. In this exemplary embodiment, a pre-formed weldable insert 30 is thereafter over-molded with the exemplary TPE in a suitable mold. Because the thermoplastic material of insert 30 is chemically compatible with the TPE of sealing component 26, a chemical interconnection occurs at interface 42. The molding conditions, i.e., pressure and temperature, provide for a better connection between the insert 30 and the sealing component 26 than could be achieved between the soft TPE used for sealing component 26 and the rigid thermoplastic material used for body portion 12 without use of insert 30.

In an alternate exemplary embodiment, cuff member 24 is formed by an over-molding process. In this exemplary embodiment, a pre-formed sealing component 26 is thereafter over-molded with the exemplary weldable insert material in a suitable mold. Because the thermoplastic material of insert 30 is chemically compatible with the TPE of sealing component 26, a chemical interconnection occurs at interface 42.

Regardless of the process used to form the unitary cuff member 24, in the exemplary embodiment, an additional step is utilized to interconnect the cuff member 24 and the body portion 12. In the exemplary embodiment a spin welding process is utilized. Spin welding is a technique used to weld thermoplastic parts with a circular-axis joint. During spin welding, one part is held stationary in a holding fixture while a second part is rotated against it under pressure at speeds from 150 to 15,000 rpm. The resulting friction causes the joining surfaces to melt and fuse together, producing a robust hermetic weld.

It is contemplated within the scope of the invention to utilize other welding techniques to accomplish the chemical interconnection between the cuff member 24 and body portion 12. The presence of insert 30, which is chemically compatible with body portion 12, provides an ability to form a robust weld between the cuff member 24 and body portion 12.

In the exemplary embodiment, the body portion 12 is formed from a blow-molding process as is known in the art. It is contemplated that other molding techniques to provide body portion 12 are within the scope of the invention.

The exemplary air duct 10 has been described with reference to a cuff member 24 at a first end 14 of body portion 12. As illustrated in FIG. 1, a similar cuff member 24 may be connected to second end 16 of body portion 12. Additionally, the disclosed process for adhering a soft TPE to a rigid thermoplastic body is not limited for use with air ducts. Many other applications will be apparent to those having skill in the art.

In the exemplary embodiment, cuff member 24 may have an annular channel 48 disposed near an end thereof for ease of attachment to other structures. For example a hose clamp can be utilized with air duct 10 for secure attachment to an engine or other automobile structure. The soft thermoplastic elastomer of which the sealing component 26 is formed provides for enhanced sealing capabilities.

Having described the features, discoveries and principles of the invention, the manner in which it is constructed and operated, and the advantages and useful results attained; the new and useful structures, devices, elements, arrangements, parts, combinations, systems, equipment, operations, methods and relationships are set forth in the appended claims.

1. Article comprising:
at least one open-ended cuff member comprising:
at least one outer sealing component section comprising a thermoplastic elastomer having a durometer hardness of less than about 90 Shore A;
at least one weldable inner insert section comprising a thermoplastic material capable of welding both to a thermoplastic body of suitable size for tight fitting insertion and to at least a portion of an inner surface of the outer sealing component section;
wherein at least one weldable inner insert section is intimately joined with the outer sealing component section at the portion of the inner surface of the outer sealing component section.

2. The article of claim 1 wherein the cuff member includes an annular channel formed on an outer surface thereof, wherein the channel is axially spaced from one end thereof.

3. The article of claim 2 further comprising:
a tubular body portion comprising the thermoplastic body having at least one annular open end region, wherein the end region is welded to the cuff member at the insert section.

4. The article of claim 3 further comprising:
a second cuff member substantially identical to the first cuff member, wherein the tubular duct member includes a second annular open end region, and wherein the second annular open end region is welded to the second cuff member at a second insert section.

5. The article of claim 1 wherein the thermoplastic elastomer has a durometer hardness of less than about 80 Shore A.

6. The article of claim 5 wherein the thermoplastic elastomer is a dynamic vulcanizate thermoplastic elastomer.

7. The article of claim 6 wherein the dynamic vulcanizate thermoplastic comprises a polyolefin thermoplastic and and at least one chemically cross-linked rubber.

8. The article of claim 7 wherein said polyolefin thermoplastics are selected from polyethylene and polypropylene homopolymers or copolymers having a Tm by DSC of at least 120°, or mixtures thereof.

9. The article of claim 8 wherein said rubber is selected from selected from natural rubber, EPM and EPDM rubber, butyl rubber, halobutyl rubber, halogenated copolymers of p-alkylstyrene and an isomonoolefin, homo or copolymers from at least one conjugated diene.

10. The artilce of claim 9 wherein said thermoplastic is a polypropylene hompolymer or copolymer and said rubber is EPDM rubber.

11. The article of claim 3 wherein the tubular body portion comprises a material selected from a rubber-modified polypropylene material, polyethylene, and polypropylene homopolymers or copolymers, or mixtures thereof.

12. A method comprising:
a) molding a cuff member comprising a sealing component section formed of a thermoplastic elastomeric material having a durometer hardness of less than about 90 Shore A, wherein the sealing component section includes an inner surface, and a weldable insert section formed of a thermoplastic material bonded to the sealing component section along at least a portion of the inner surface of the sealing component section, wherein the weldable insert includes an inner surface;
b) welding a thermoplastic body portion to the cuff member wherein an end region of the thermoplastic body is welded to the inner surface of the weldable insert.

13. The method of claim 12 wherein in (a) the cuff member is molded in a two-shot injection molding process wherein one shot includes the thermoplastic elastomeric material for forming the sealing component section and another shot includes the thermoplastic material for forming the weldable insert section.

14. The method of claim 10 wherein in (a) the cuff member is molded in an insert over-molding process wherein the weldable insert section is pre-formed in an initial process step and the sealing component section is subsequently molded over an outer surface of the weldable insert section.

15. The method of claim 10 wherein in (a) the cuff member is molded in an insert over-molding process wherein the sealing component section is pre-formed in an initial process step and the weldable insert section is subsequently molded onto an inner surface of the sealing component.

16. The method of claim 10 wherein in (b) welding the thermoplastic body to the cuff member comprises a spin welding operation or other suitable welding techniques.
